(19) United States
(12) Patent Application Publication
(10) Pub. No.: US 2026/0068855 A1
(43) Pub. Date: Mar. 12, 2026

(54) Hydrating Harness

(71) Applicant: Denton A. Johnson, Johnson City, NY (US)

(72) Inventor: Denton A. Johnson, Johnson City, NY (US)

(21) Appl. No.: 19/327,818

(22) Filed: Sep. 12, 2025

Related U.S. Application Data
(60) Provisional application No. 63/693,996, filed on Sep. 12, 2024.

(51) Int. Cl. A01K 27/00; A01K 7/00

(52) U.S. Cl. CPC A01K 27/002; A01K 7/00

(57) ABSTRACT

A dog harness bearing two apertures for the legs of the dog to be inserted through. The harness bears at least one water pouch, in which the flow of the water is controlled by a pump, that can be manual or battery operated. The harness bears a divot to allow the water pouch to be positioned on either the left side or the right side of the harness. A hose connects the water pouch to a cup, which can be attached to the backside of the harness when not in use. The harness bears a hook to allow a leash to be attached.

### FIELD OF THE INVENTION

The present invention relates generally to a dog harness. More specifically, the dog harness comprises water pouches and a cup. The water pouches can pump water into the cup through a straw.

### BACKGROUND OF THE INVENTION

A dog harness, an equipment consisting of straps that surround the dog's torso, is used to guide and hold the dog. Generally, a leash is attached to the dog harness to have the dog under control. The present invention adds improvements and additional features to the ordinary dog harness.

An objective of the present invention is to provide a dog harness with water pouches and a cup. The water pouches can pump water through a straw and the pumped water is poured into the cup using a battery-powered pump. Further, the present invention provides a waterproof feature therefore, a dog with the present invention is accessible to drinking water anywhere and anytime. Additional features and benefits are further discussed in the sections below.

### BRIEF DESCRIPTION OF THE DRAWINGS

FIG. 1 is a front right perspective view of the present invention;

FIG. 2 is a top view of the present invention;

FIG. 3 is a top view of the present invention with the water pouch being detached;

FIG. 4 is an exemplary illustration of the present invention being worn on a dog;

FIG. 5 is an front-left view model of the present invention, depicting its components;

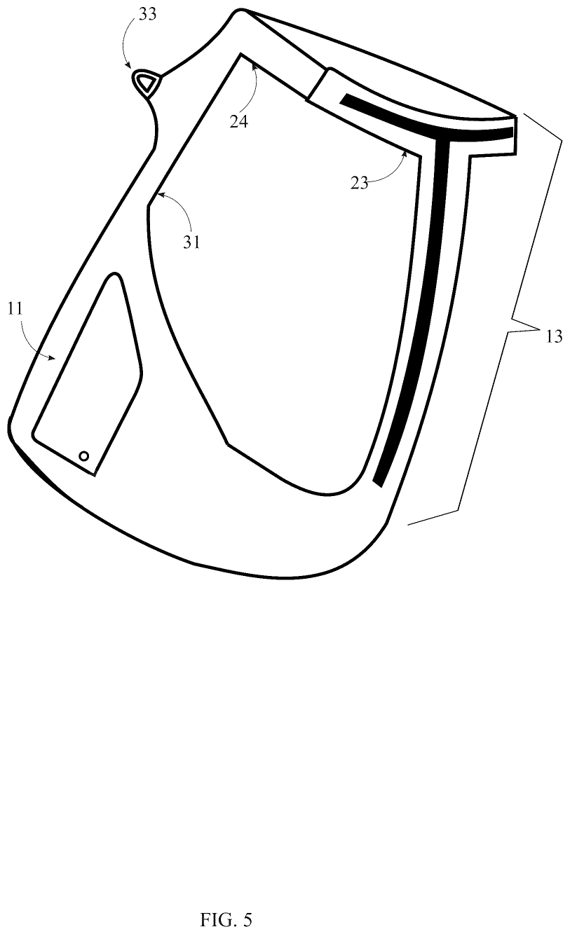

FIG. 6 is a top view model of the present invention with the cup removed.

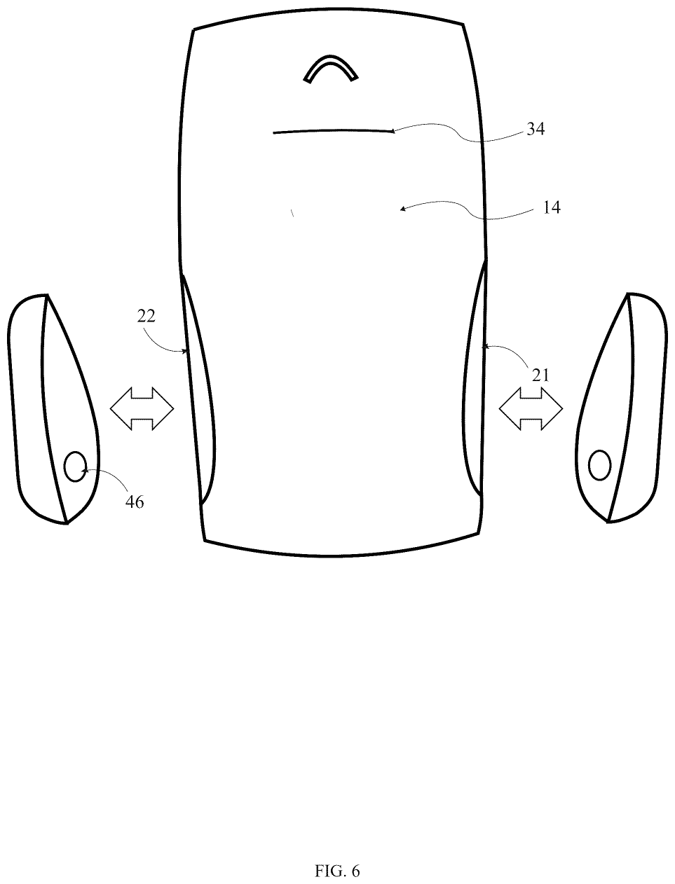

### DETAIL DESCRIPTIONS OF THE INVENTION

All illustrations of the drawings are for the purpose of describing selected versions of the present invention and are not intended to limit the scope of the present invention.

The present invention provides a dog harness 10 with water pouch 41es and a cup 43. Unlike ordinary dog harness 10es, the present invention allows a dog to carry drinking water with the cup 43 for himself/herself. In a preferred embodiment, the present invention comprises a harness 10, a cup 43, a hose 42, and at least one water pouch 41. The harness 10 is designed to surround the dog's torso. The cup 43 is for holding drinking water. The hose 42 is a passage of drinking water to the cup 43. In the preferred embodiment, the hose 42 is permanently attached to the cup 43 while the connection between the plurality of water pouch 41es is detachable. The at least one water pouch 41 carries drinking water.

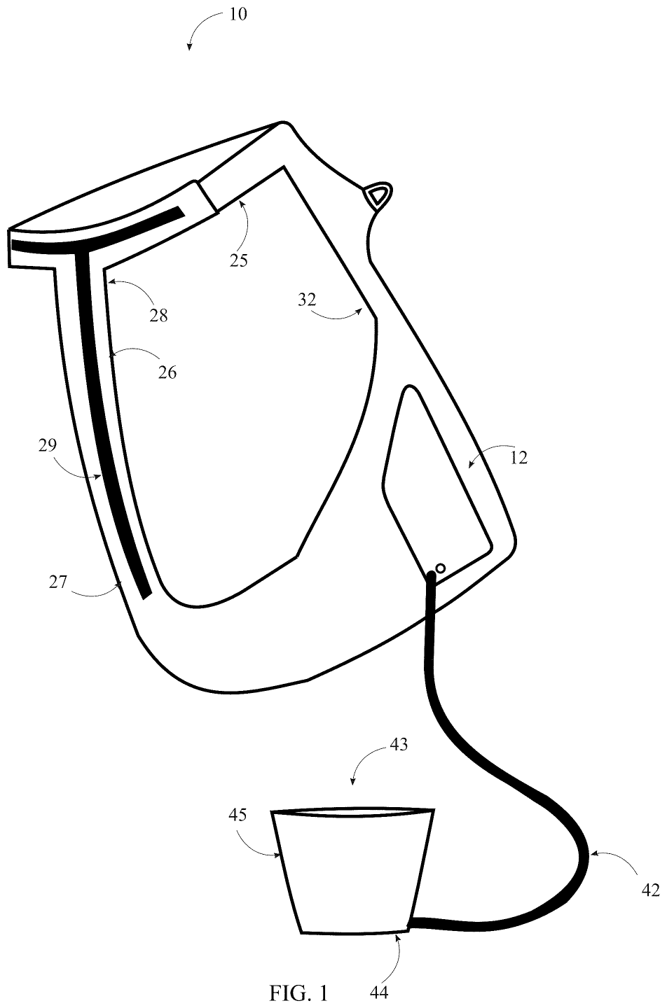

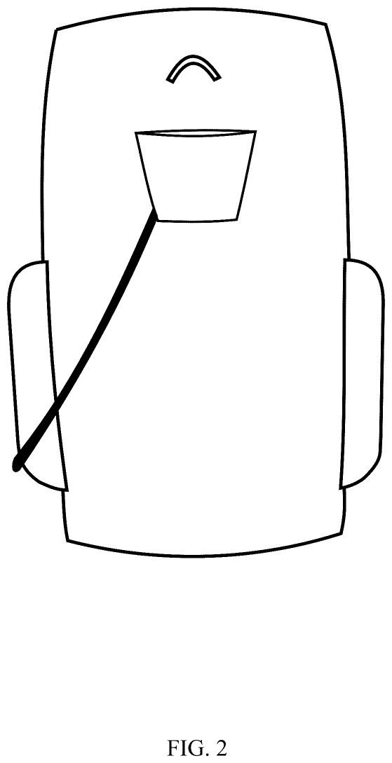

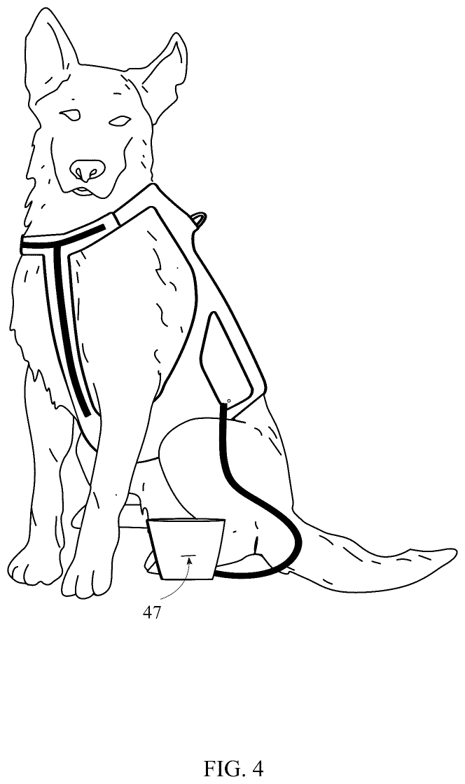

As can be seen in FIGS. 1, 2, and 4, the harness 10 provides a vest-like structure for dogs, although any desired design may be used. In the preferred embodiment, some of outer surfaces of the harness 10 are covered with reflective fabrics that help prevent accidents during low-light conditions. Further, the harness 10 is made of waterproof material so that the dog can go into water while wearing the present harness 10. The harness 10 comprises a collar 13, a spine panel, a left wing 11, and a right wing 12. The spine panel is the section of fabric of the harness 10 that is positioned down the dogs back. The spinal panel 14 has a left edge and a right edge. The left wing 11 is attached to the left edge of the spinal panel 14. Similarly, the right wing 12 being attached to the right edge of the spinal panel. The left wing 11 further comprises a left indent 21 21 and the right wing 12 comprises a right indent 22.

The collar 13 is T-shaped and comprises a midline band 26 and a neck strap 23, which forms the T-shape. The midline band 26 is positioned perpendicular to the neck strap 23. The midline band 26 comprises a distal end 27 and a proximal end 28 and the proximal end 28 is centrally positioned to the neck strap 23. The collar 13 further comprises a reflective belt 29 which traverses the neck strap 23 and the midline band 26. The reflective belt 29 is centrally positioned on the neck strap 23 and is also centrally positioned on the midline band 26. A left aperture is formed by the neck strap 23 the left edge of the spinal panel 14 and the midline band 26. A right aperture is formed by the neck strap 23 the left edge of the spinal panel 14 and the midline band 26.

The neck strap 23 has a left boundary 24 and a right boundary 25. The right boundary 25 attaches to the right edge of the spinal panel 14 opposite the right wing 12. The left boundary 24 attaches to the left edge of the spinal panel 14 opposite the right wing 12.

The harness 10 comprises a leash hook and a cup 43 holder. Both the leash hook and the attachment groove are located on the exterior surface of the harness 10. The leash hook provides a D-ring shape that allows a leash to be securely connected to the harness 10. The cup 43 holder accommodates the cup 43. The cup 43 holder provides an attachment groove that allows a stable attachment to the cup 43.

The cup 43 bears a notch 47 which attaches to the attachment groove. The cup 43 comprises a bas 44 and a support wall 45. The support wall 45 is perimetrically positioned around the base 44. A hose 42 connects from the at least one water pouch 41 and the cup 43.

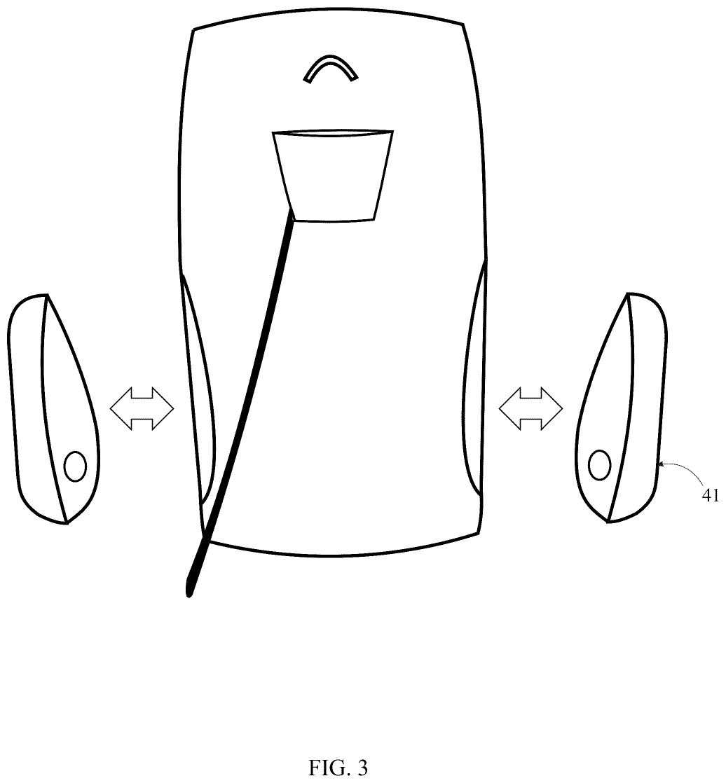

As can be seen in FIG. 3, the at least one water pouch 41 is detachable from the harness 10. In the preferred embodiment, the at least one pouch has a pump 46 integrated into the pouch. The pump 46 is battery powered and pushing a button of the pump 46 allows drinking water to flow through the hose 42. The battery may be replaced when the power runs out. The water hole is an opening that allows a user to refill the water pouch 41. The cap is a closure of the water hole and is screw cap. The at least one water pouch 41 is made of insulation materials. The insulation material keeps drinking water cool. The at least one water pouch 41 is positioned within the left indent 21 or the right indent 22.

There are two versions of the present invention, one with the cup 43 connected then one without the cup 43 connected. The present invention's battery function can be replaced, recharged, and/or modified.

Although the invention has been explained in relation to its preferred embodiment, it is to be understood that many other possible modifications and variations can be made without departing from the spirit and scope of the invention.

What is claimed is:

1. A dog harness comprising:
a collar;
a spinal panel;
a left aperture;
a right aperture;
a left wing; and
a right wing;
a water system;
the water system comprising a cup, a hose, and at least one water pouch; and
the spinal panel comprising a left edge and a right edge.

2. The dog harness as in claim 1 comprising:
the left wing being attached to the left edge of the spinal panel; and
the right wing being attached to the right edge of the spinal panel.

3. The dog harness as in claim 1 comprising:
the collar comprising a midline band and a neck strap;
the midline band being positioned perpendicular to the neck strap;
the midline band comprising a distal end and a proximal end; and
the proximal end of the midline band being centrally positioned on the neck strap.

4. The dog harness as in claim 3 comprising:
the collar comprising a reflective belt;
the reflective belt being centrally positioned on the neck strap; and
the reflective belt being centrally positioned along the midline band.

5. The dog harness as in claim 1 comprising;
The left wing comprising a left indent; and
The right wing comprising a right indent.

6. The dog harness as in claim 3 comprising:
the neck strap having a left boundary and a right boundary;
the right boundary attaching to the right edge of the spinal panel opposite the right wing.
the left boundary attaching to the left edge of the spinal panel opposite the right wing.

7. The dog harness holder as in claim 5 comprising:
the at least one water pouch being positioned within the left or the right indent.

8. A dog harness holder as in claim 1 comprising:
the cup comprising a base and a support wall;
the cup having a notch;
the support wall being perimetrically positioned around the base; and
the hose connecting from the at least one water pouch to the cup.

9. The dog harness holder as in claim 1 comprising:
the spinal panel having an exterior surface;
a leash hook being positioned on the exterior surface of the spinal panel;
an attachment groove being positioned about the exterior surface of the spinal panel;
a pump being integrated with the at least one water pouch.

10. A dog harness comprising:
a collar;
a spinal panel;
a left aperture;
a right aperture;
a left wing; and
a right wing;
a water system;
the water system comprising a cup, a hose, and at least one water pouch.
the spinal panel comprising a left edge and a right edge;
the left wing being attached to the left edge of the spinal panel; and
the right wing being attached to the right edge of the spinal panel.

11. The dog harness holder as in claim 10 comprising:
the collar comprising a midline band and a neck strap;
the midline band being positioned perpendicular to the neck strap;
the midline band comprising a distal end and a proximal end;
the proximal end of the midline band being centrally positioned on the neck strap;
the collar comprising a reflective belt;
the reflective belt being centrally positioned on the neck strap; and
the reflective belt being centrally positioned along the midline band.

12. The dog harness as in claim 11 comprising:
The left wing comprising a left indent;
The right wing comprising a right indent;
the neck strap having a left boundary and a right boundary;
the right boundary attaching to the right edge of the spinal panel opposite the right wing;
the left boundary attaching to the left edge of the spinal panel opposite the right wing; and
the at least one water pouch being positioned within the left or the right indent

13. A dog harness holder as in claim 10 comprising:
the cup comprising a base and a support wall;
the cup having a notch;
the support wall being perimetrically positioned around the base;
the hose connecting from the at least one water pouch to the cup;
the spinal panel having an exterior surface;
a leash hook being positioned on the exterior surface of the spinal panel;
an attachment groove being positioned about the exterior surface of the spinal panel; and
a pump being integrated with the at least one water pouch.
